(19) United States
(12) Patent Application Publication
(10) Pub. No.: US 2026/0080506 A1
(43) Pub. Date: Mar. 19, 2026

(54) DYNAMIC AND ADAPTIVE IMAGE BRIGHTNESS ENHANCEMENT

(71) Applicant: Samsung Electronics Co., Ltd., Suwon-si (KR)

(72) Inventor: Yingen Xiong, Mountain View, CA (US)

(21) Appl. No.: 19/289,865

(22) Filed: Aug. 4, 2025

Related U.S. Application Data
(60) Provisional application No. 63/696,799, filed on Sep. 19, 2024.

(51) Int. Cl. G06T 5/40; G06T 7/11

(52) U.S. Cl. CPC G06T 5/40; G06T 7/11; G06T 2207/10024

(57) ABSTRACT

A method includes obtaining, using at least one imaging sensor of an electronic device, a color image frame of a scene. The method also includes determining, using at least one processing device of the electronic device, that a visual quality of the color image frame falls outside of a visual quality threshold. The method further includes, in response to determining that the visual quality of the color image frame falls outside of the visual quality threshold, performing, using the at least one processing device, visual quality enhancement to the color image frame to generate a modified image frame. In addition, the method includes applying, using the at least one processing device, one or more passthrough transformations to the modified image frame to generate a transformed image frame.

### CROSS-REFERENCE TO RELATED APPLICATION AND PRIORITY CLAIM

This application claims priority under 35 U.S.C. § 119 (e) to U.S. Provisional Patent Application No. 63/696,799 filed on Sep. 19, 2024, which is hereby incorporated by reference in its entirety.

### TECHNICAL FIELD

This disclosure relates generally to image processing systems and processes. More specifically, this disclosure relates to dynamic and adaptive image brightness enhancement.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to dynamic and adaptive image brightness enhancement.

In a first embodiment, a method includes obtaining, using at least one imaging sensor of an electronic device, a color image frame of a scene. The method also includes determining, using at least one processing device of the electronic device, that a visual quality of the color image frame falls outside of a visual quality threshold. The method further includes, in response to determining that the visual quality of the color image frame falls outside of the visual quality threshold, performing, using the at least one processing device, visual quality enhancement to the color image frame to generate a modified image frame. In addition, the method includes applying, using the at least one processing device, one or more passthrough transformations to the modified image frame to generate a transformed image frame.

In a second embodiment, an apparatus includes at least one processing device configured to obtain a color image frame of a scene and determine that a visual quality of the color image frame falls outside of a visual quality threshold. The at least one processing device is also configured, in response to determining that the visual quality of the color image frame falls outside of the visual quality threshold, to perform visual quality enhancement to the color image frame to generate a modified image frame. The at least one processing device is further configured to apply one or more passthrough transformations to the modified image frame to generate a transformed image frame.

In a third embodiment, a non-transitory machine readable medium contains instructions that when executed cause at least one processor of an electronic device to obtain a color image frame of a scene. The non-transitory machine readable medium also contains instructions that when executed cause the at least one processor to determine that a visual quality of the color image frame falls outside of a visual quality threshold. The non-transitory machine readable medium further contains instructions that when executed cause the at least one processor, in response to determining that the visual quality of the color image frame falls outside of the visual quality threshold, to perform visual quality enhancement to the color image frame to generate a modified image frame. In addition, the non-transitory machine readable medium contains instructions that when executed cause the at least one processor to apply one or more passthrough transformations to the modified image frame to generate a transformed image frame.

Any one or any combination of the following features may be used with the first, second, or third embodiment. The visual quality of the color image frame may be determined to fall outside of the visual quality threshold by segmenting the color image frame into a plurality of regions; obtaining regional visual quality parameters for each of the regions and global visual quality parameters for the color image frame; identifying a regional visual quality threshold for each region based on the regional visual quality parameters associated with the region; and identifying a global visual quality threshold for the color image frame based on the global visual quality parameters. The regional visual quality parameters may include a regional signal-to-noise ratio, a regional brightness, and a regional histogram. The global visual quality parameters may include a global signal-to-noise ratio, a global brightness, and a global histogram.

The visual quality of the color image frame may be determined to fall outside of the visual quality threshold by labeling one or more first regions to be enhanced and one or more second regions to not be enhanced. Each first region may have an associated regional visual quality parameter that falls outside of the regional visual quality threshold associated with the first region. Each second region may have an associated regional visual quality parameter within the regional visual quality threshold associated with the second region.

The visual quality enhancement may be performed by applying a local visual enhancement to one or more of the regions and/or applying a global visual enhancement to the color image frame. The local visual enhancement may be applied by selecting one or more visual enhancement algorithms for the one or more regions and applying the one or more visual enhancement algorithms to the one or more regions. The global visual enhancement may be applied by selecting one or more global visual enhancement algorithms for the color image frame. The one or more visual enhancement algorithms may include at least one of: a histogram processing, a contrast processing, or an exposure processing. The one or more global visual enhancement algorithms may include at least one of: a histogram processing, an exposure processing, a contrast processing, or a relighting. The one or more visual enhancement algorithms may be applied to the color image frame such that the brightness is more consistent throughout the color image frame.

A color format of the color image frame may be converted. A luminance component may be extracted from the converted color format of the color image frame. Brightness of the color image frame may be determined using the luminance component.

A final image frame may be rendered for display based on the transformed image frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for dynamic and adaptive image brightness enhancement in accordance with this disclosure;

FIGS. 3A-3C illustrate example functions in the process of FIG. 2 in accordance with this disclosure;

FIG. 4 illustrates an example technique for region design for an image frame 401 capturing a scene in accordance with this disclosure;

FIGS. 5A-5B illustrate example results obtainable using dynamic and adaptive image brightness enhancement in accordance with this disclosure; and

FIG. 6 illustrates an example method for dynamic and adaptive image brightness enhancement in accordance with this.

### DETAILED DESCRIPTION

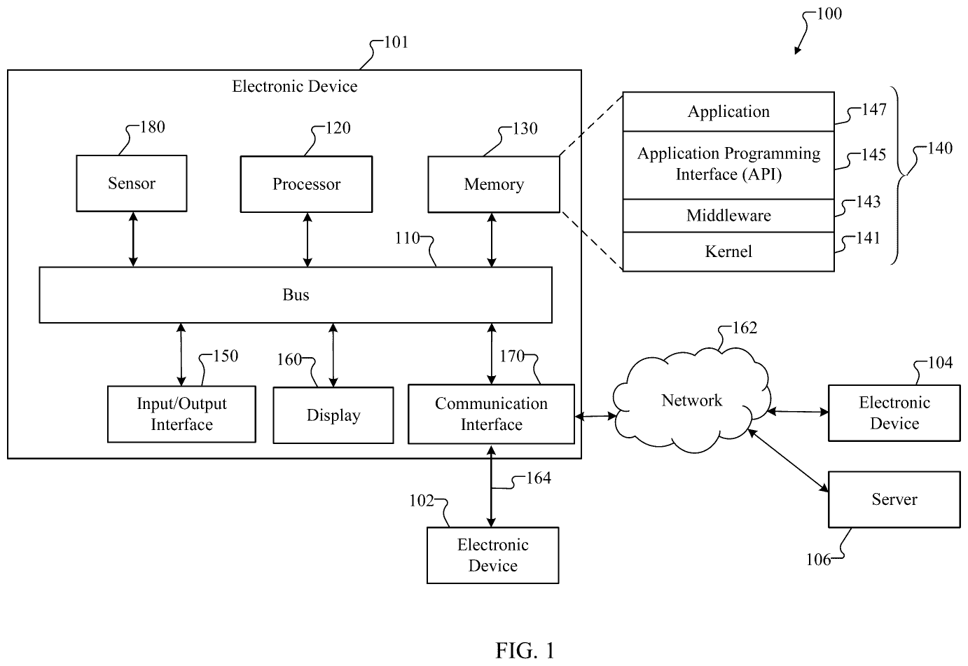

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “sec-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that the image quality of the captured image frames can be negatively affected by conditions in the surrounding environment and properties of the imaging sensors themselves. For example, when inadequate lighting is available in the user's surrounding environment, captured image frames can appear dark and noisy, which makes it difficult for the user to discern content in the captured environment and can even cause user discomfort. Some approaches adjust brightness of a captured image frame as a whole. However, these approaches do not work well in cases involving a captured image frame having portions with different brightnesses. For instance, an image frame capturing fireworks may include a bright portion that does not need brightness enhancement and a dark portion that needs brightness enhancement.

This disclosure provides various techniques supporting dynamic and adaptive image brightness enhancement for XR or other applications. As described in more detail below, a color image frame of a scene can be obtained, and a determination can be made that a visual quality of the color image frame falls outside of a visual quality threshold. In response to determining that the visual quality of the color image frame falls outside of the visual quality threshold, visual quality enhancement can be performed to the color image frame in order to generate a modified image frame. In some cases, one or more first regions to be enhanced and one or more second regions to not be enhanced can be labeled, where (i) each first region has an associated regional visual quality parameter that falls outside of a regional visual quality threshold associated with the first region and (ii) each second region has an associated regional visual quality parameter within the regional visual quality threshold associated with the second region. The visual quality enhancement may include a local visual enhancement applied to one or more of the regions and/or a global visual enhancement applied to the color image frame. One or more passthrough transformations can be applied to the modified image frame in order to generate a transformed image frame.

In this way, the described techniques support dynamic and adaptive image brightness enhancement, which can provide visually-enhanced low-light images based on sec-through color frames or other images. Among other things, the described techniques can dynamically apply different strategies for enhancing image frames in different low-light conditions. The described techniques can also enhance different local regions in the image frames according to brightness states of the different local regions and adaptively decide how much enhancement each local region receives. In addition, after local enhancement, the described techniques can finalize visual enhancement for the entire image frames, such as to make brightness consistent across the entire image frames. These techniques can therefore significantly improve the quality of the resulting images that are generated, which can increase or optimize a user's experience.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to dynamic and adaptive image brightness enhancement in XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform dynamic and adaptive image brightness enhancement. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to dynamic and adaptive image brightness enhancement in XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

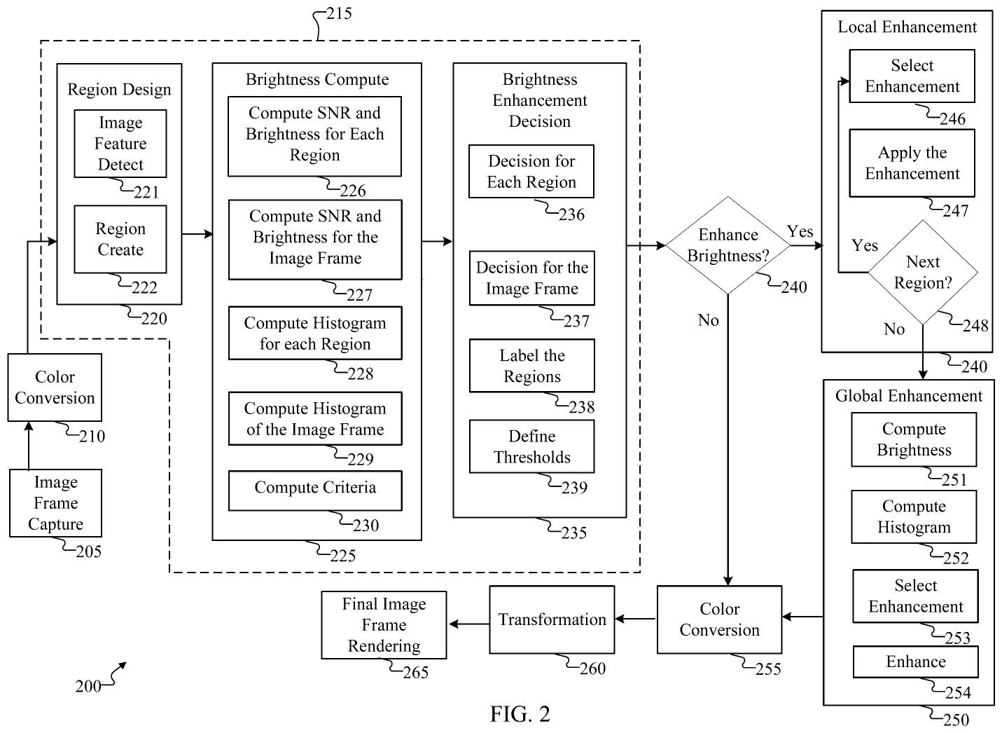

FIG. 2 illustrates an example process 200 for dynamic and adaptive image brightness enhancement in accordance with this disclosure. For ease of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s). Also, while FIG. 2 describes visual enhancement associated with brightness enhancement, it will be understood that visual enhancement associated with other enhancement(s), such as color correction, can be applied without departing from the scope of this disclosure.

As shown in FIG. 2, the process 200 includes an image frame capture operation 205, which generally operates to capture one or more image frames of a scene. This may include the processor 120 obtaining the one or more image frames and optionally depth data of the surroundings in the scene. In some cases, each image frame may be a high-resolution color image frame, such as one captured by the electronic device 101 using one or more imaging sensors 180 of the electronic device 101. Also, in some cases, each captured image frame may represent an image frame of a scene captured by a forward-facing camera or other imaging sensor(s) 180 of the electronic device 101. The one or more captured image frames can undergo one or more passthrough transformations as described below.

A conversion operation 210 generally operates to convert each captured image frame from a first image format that lacks luminance data to a second image format that includes luminance data. Any suitable image formats may be supported here. As particular examples, the image frames obtained by the image frame capture operation 205 may be in an RGB format, and the image frames may be converted into a YUV or YCbCr format or a hue, saturation, and value (HSV) format. The luminance data includes a luminance component or channel (Y or V) of the color converted format. In embodiments in which the conversion operation 210 is used, this conversion allows for lightness adjustment of transformed image frames for visibility enhancement. Note, however, that use of the conversion operation 210 is optional.

A brightness enhancement analysis operation 215 generally operates to identify the brightness status of each image frame to determine whether brightness enhancement is needed for the image frame. In this example, the brightness enhancement analysis operation 215 includes a region design operation 220, a brightness compute operation 225, and a brightness enhancement decision operation 235. The region design operation 220 generally operates to create a plurality of regions in each image frame. In this example, the region design operation 220 includes an image feature detection operation 221 and a region creation operation 222.

The image feature detection operation 221 generally operates to detect and extract image features from each image frame. This may include the processor 120 of the electronic device 101 detecting one or more image features (such as an object) within an image frame and extracting the one or more image features to generate one or more regions in the image frame. The region creation operation 222 generally operates to create a plurality of regions based on the extracted image features. This may include the processor 120 adjusting a pre-designed grid used by the electronic device 101 (such as one defined at manufacturing or another) or other suitable pattern and applying the adjusted pattern to the image frame. For example, if the extracted features include a high number of minute details, the grid or other pattern may be adjusted to increase the number of regions and decrease the size(s) of the regions so as to allow for brightness enhancement of the minute details. The adjustment to the grid or other pattern may be applied uniformly to the entire pattern or applied distinctively to individual regions, depending on the extracted image features to be covered by corresponding regions. In some circumstances, only one region may be created for the whole image frame, and brightness enhancement (if needed) can be applied globally to the whole image frame.

The brightness compute operation 225 generally operates to analyze the brightness of the extracted image features. In this example, the brightness compute operation 225 includes a local brightness compute operation 226, a global brightness compute operation 227, a local histogram compute operation 228, a global histogram compute operation 229, and a brightness criteria compute operation 230. The local brightness compute operation 226 generally operates to determine the brightness of each of the one or more regions. This may include the processor 120 determining one or more local brightness metrics, such as a signal-to-noise ratio SNRᵢ and brightness for each region.

In some embodiments, SNR for a current region being processed may be determined in the following manner.

$${P}_{signal}^{i} = {P}_{mean}^{i} \qquad EQ . 1$$

### Here,

$${P}_{mean}^{i}$$

represents a mean pixel value of an image region i. A mean μᵢ and a variation

$${σ}_{i}^{2}$$

of the standard deviation σᵢ for an image/including a pixel pⱼ(x, y) can be determined in the following manner.

$$\{ \begin{matrix}{μ}_{i} = \frac{1}{N} {\sum }_{j = 1}^{N} I ( {p}_{j} ( x , y ) ) \\ {σ}_{i}^{2} = \frac{1}{N} {\sum }_{j = 1}^{N} I ( {{p}_{j} ( x , y )}^{2} - {μ}_{i}^{2} )\end{matrix} \qquad EQ . 2$$

The signal-to-noise ratio of the image region i can be determined as follows.

$${SNR}_{i} = 10 {log}_{10}^{( \frac{{P}_{signal}^{i}}{{P}_{noise}^{i}} )} \qquad EQ . 3$$

### Here,

$${P}_{noise}^{i}$$

represents noise and may be expressed as follows.

$${P}_{noise}^{i} = {σ}_{i} \qquad EQ . 4$$

In some embodiments, the brightness of the image region i may be defined as follows.

$${Brightness}_{i} = {B}_{i} ( {μ}_{i} , {σ}_{i} ) \qquad EQ . 5$$

The global brightness compute operation 227 generally operates to determine the global brightness of the entirety of each image frame. This may include the processor 120 determining one or more global brightness metrics, such as signal-to-noise ratio SNR_{f} and brightness of the entirety of each image frame. In some embodiments, SNR_{f} for an entire image frame being processed may be determined in the following manner.

$${P}_{signal}^{f} = {P}_{mean}^{f} \qquad EQ . 6$$

### Here

$${P}_{mean}^{f}$$

represents a mean pixel value of an image I. A mean μ_{f} and a variation

$${σ}_{f}^{2}$$

of the standard deviation σᵢ for the image/including a pixel pⱼ(x, y) can be determined in the following manner.

$$\{ \begin{matrix}{μ}_{f} = \frac{1}{N} {\sum }_{j = 1}^{N} I ( {p}_{j} ( x , y ) ) \\ {σ}_{f}^{2} = \frac{1}{N} {\sum }_{j = 1}^{N} I ( {{p}_{j} ( x , y )}^{2} - {μ}_{f}^{2} )\end{matrix} \qquad EQ . 7$$

The signal-to-noise ratio SNR_{f} of the image I can be determined as follows.

$${SNR}_{f} = 10 {log}_{10}^{( \frac{{P}_{signal}^{f}}{{P}_{noise}^{f}} )} \qquad EQ . 8$$

### Here,

$${P}_{noise}^{f}$$

represents noise and may be expressed as follows.

$${P}_{noise}^{f} = {σ}_{f} \qquad EQ . 9$$

In some embodiments, the brightness of the image I may be defined as follows.

$${Brightness}_{f} = {B}_{f} ( {μ}_{f} , {σ}_{f} ) \qquad EQ . 10$$

The local histogram compute operation 228 generally operates to determine regional histograms for regions of image frames. This may include the processor 120 determining histograms for each of the plurality of regions in each image frame based on corresponding extracted image features therein. In some embodiments, a local histogram for each image region i may be determined as follows.

$${H}_{i} = h ( I ( {p}_{i} ( x , y ) ) \qquad EQ . 11$$

The global histogram compute operation 229 generally operates to determine a global histogram of each image frame. This may include the processor 120 determining a histogram of the entirety of each image frame, which can help to define the brightness distribution over the image frame. In some embodiments, a global histogram for each image/can be determined as follows.

$${H}_{f} = h ( I ( p ( x , y ) ) . \qquad EQ . 12$$

The brightness criteria compute operation 230 generally operates to determine one or more brightness criteria of individual regions of each image frame and of each image frame as a whole. This may include the processor 120 identifying intrinsic and extrinsic parameters of one or more imaging sensors 180 used to capture the image frames and identifying a local optimum brightness of each of the plurality of regions in each image frame based on the parameters, the environment in which the image frame was captured, and the corresponding extracted image features. This may also include the processor 120 identifying one or more local brightness criteria for each of the plurality of regions in each image frame based on the identified local optimum brightness.

As an example of this, if an image frame includes fireworks in one area and spectators in another area, the optimum local brightness for the fireworks area can be higher than the optimum local brightness for the spectator area. In this example, the local brightness criteria for the fireworks and spectator areas can be identified based on corresponding optimum local brightnesses in the environment in which the image frame was captured. Thus, for instance, the optimum local brightness for the fireworks area may have a higher intensity level (such as a value of 70), while the optimum local brightness for the spectator area may have a lower intensity level (such as a value of 45). As such, the local brightness criteria for a region including the fireworks may be a higher percentage (such as 65%) of the pixels above the corresponding intensity level.

The brightness criteria compute operation 230 can further include the processor 120 identifying a global optimum brightness of each image frame as a whole based on various parameters, the environment in which the image frame was captured, and the image frame as a whole. This may also include the processor 120 identifying one or more global brightness criteria for each image frame based on the corresponding global optimum brightness. In the above example with an image frame having fireworks and spectators, the optimum global brightness of the image frame may be, for example, an intensity level of 55. In this example, a global brightness criteria for the image frame as a whole may be 60% of the pixels above the intensity level of 55.

Note that one or more parameters of each imaging sensor 180 used to capture the image frames are typically created or identified by manufacturer calibration and stored in the electronic device 101. In some embodiments, for example, the electronic device 101 may include one or more functions that allow users or developers to update one or more parameters if needed. For example, a calibration board with specified patterns may be provided, and a user could print the calibration board. One or more imaging sensors 180 may be used to capture images of the calibration board, and the processor 120 may determine one or more parameters automatically. Upon obtaining user permissions or automatically, the electronic device 101 can update the stored parameter(s) of one or more imaging sensors 180.

The brightness enhancement decision operation 235 generally operates to determine whether brightness enhancement is needed for each image frame. In this example, the brightness enhancement decision operation 235 includes a local brightness enhancement decision operation 236, a global brightness enhancement decision operation 237, a label operation 238, and a threshold identification operation 239. The local brightness enhancement decision operation 236 generally operates to identify one or more regions in which local brightness enhancement will be applied. This may include the processor 120 obtaining local histograms and brightness metrics (such as SNRᵢ and Bᵢ(μ, σ)), comparing the local brightness metrics to corresponding identified local brightness criteria, and determining whether local brightness enhancement should be applied to any of the regions based on the comparison. For example, if the Bᵢ(μ, σ)) metric for one or more regions is determined to be outside of the identified local brightness criteria, the processor 120 can determine that local brightness enhancement should be applied to those regions. In some cases, the local brightness criteria may change based on the type of local brightness enhancements being applied.

The global brightness enhancement decision operation 237 generally operates to determine whether global brightness enhancement will be applied to each image frame as a whole. This may include the processor 120 obtaining global histogram and parameters (such as SNR_{f} and brightness B_{f}(μ, σ)), comparing the global brightness metrics to the identified global brightness criteria, and determining whether the global brightness enhancement should be applied to an image frame as a whole. For example, if the global histogram exhibits a large concentration of pixels at low intensities, a narrow intensity range, or skewness towards dark or bright ends, the processor 120 can determine that global brightness enhancement should be applied to the image frame as a whole, such as to achieve more consistency in brightness throughout the image frame.

The label operation 238 generally operates to classify the plurality of regions of each image frame based on the determination of whether local brightness enhancement should be applied. This may include the processor 120 labeling each region that should receive local brightness enhancement. This may also include the processor 120 classifying or excluding the regions that do not need local brightness enhancement.

The threshold identification operation 239 generally operates to identify brightness enhancement thresholds. This may include the processor 120 identifying local brightness enhancement thresholds for one or more regions to which local brightness enhancement should be applied. In the above example with an image frame having fireworks and spectators, local brightness enhancement thresholds may be the same as the corresponding optimum local brightnesses (such as the intensity level of 70 for one or more regions including the fireworks). This may also include the processor 120 identifying a global brightness enhancement threshold for an image frame as a whole. In the above example with an image frame having fireworks and spectators, the global brightness enhancement threshold may be the optimum global brightness (such as the intensity level of 55).

A determination operation 240 generally operates to determine whether each image frame should receive brightness enhancement. This may include the processor 120 identifying any region of an image frame that should receive brightness enhancement based on the local brightness enhancement decision made at operation 236, and the processor 120 can perform local brightness enhancement for one or more regions labeled for brightness enhancement. If no region of an image frame needs brightness enhancement, the processor 120 may convert the color format of the image frame back to the original color format or to a different color format and pass the image frame for passthrough transformation. Note, however, that conversion of the color format is optional.

A local brightness enhancement operation 245 generally operates to perform adaptive local brightness enhancement, such as for one or more regions of each image frame labeled for enhancement. This may include the processor 120 obtaining each of the one or more regions labeled for enhancement and performing local brightness enhancement that is adaptive to the associated brightness metrics for that region. In this example, the local brightness enhancement operation 245 includes a selection operation 246, an application operation 247, and a determination operation 248. The selection operation 246 generally operates to identify a local brightness enhancement appropriate for each of the one or more regions labeled for enhancement based on the corresponding brightness metrics.

In some embodiments, local brightness enhancement may include adaptive local histogram processing, adaptive local contrast processing, adaptive local exposure processing, and the like. In adaptive local histogram processing, a pixel value at a kth level may be determined as follows.

$${p}_{k} = \frac{( L - 1 )}{w \times h} {\sum }_{j = 0}^{k} {n}_{j} \qquad EQ . 13$$

Here, nⱼ represents a number of pixels in an image having a j^{th} intensity level, L represents an intensity level of the image, w represents the width of the image, and h represents the height of the image. In adaptive contrast processing, a pixel value g(x, y) for a transformed image from an original pixel value f(x, y) may be determined as follows.

$$g ( x , y ) = α f ( x , y ) + β \qquad EQ . 14$$

Here, α represents a gain parameter (greater than zero), and β represents a bias parameter. In adaptive exposure processing, a pixel value g(x, y) for a transformed image from an original pixel value f(x, y) may be determined as follows.

$$g ( x , y ) = f ( x , y ) \times {2}^{c} \qquad EQ . 15$$

Here, c represents a parameter of exposure compensation.

The application operation 247 generally operates to apply one or more selected local brightness enhancement techniques. This may include the processor 120 performing one or more selected adaptive histogram processing, contrast processing, exposure processing, and the like to each of the corresponding regions labeled for enhancement. The determination operation 248 generally operates to determine whether all of the one or more regions labeled for enhancement have been enhanced. This may include the processor 120 identifying any remaining regions labeled for enhancement (if any) and iteratively performing the selection operation 246 and the application operation 247 for each of the remaining regions. This may continue until one or more selected local brightness enhancements have been applied to all of the one or more regions labeled for enhancement. Note, however, that serial application of the local brightness enhancements is optional and that the local brightness enhancements may be performed in other ways, such as in parallel.

A global brightness enhancement operation 250 generally operates to finalize brightness enhancement by performing global brightness enhancement to each image frame (if needed), such as to achieve brightness consistency throughout each image frame. In this example, the global brightness enhancement operation 250 includes a global brightness compute operation 251, a global histogram compute operation 252, a selection operation 253, and an application operation 254. The global brightness compute operation 251 generally operates to determine one or more global brightness metrics (such as the signal-to-noise ratio SNR_{f} and brightness B_{f}(μ, σ)) for locally-enhanced image frames, such as by using Equations (8) and (10). The global histogram compute operation 252 generally operates to determine a global histogram H_{f} of each locally-enhanced image frame, such as by using Equation (12).

The selection operation 253 generally operates to identify an appropriate global brightness enhancement based on the computed signal-to-noise ratio SNR_{f}, brightness B_{f}(μ, σ), and histogram H_{f} for each image frame. This may include the processor 120 identifying one or more of histogram processing, contrast processing, exposure processing, or relighting as appropriate to globally-enhance a locally-enhanced image frame. Histogram processing, contrast processing, and exposure processing can be applied to an image frame in the same or similar manner as during the adaptive local histogram processing, contrast processing, and exposure processing discussed above (but in a global context). Relighting can be performed, such as by using a light source adjustment model or as any combination of the histogram processing, contrast processing, and exposure processing. In the above example with an image frame having fireworks and spectators, a light source adjustment model may add a virtual soft light source above the spectators in order to enhance the visibility of the spectators without overexposing the fireworks.

The application operation 254 generally operates to apply the selected global brightness enhancement to each locally-enhanced image frame to generate a final brightness-enhanced image frame. In some embodiments, the global brightness enhancement may adjust the brightness of one or more locally-enhanced regions of an image frame to ensure consistency of brightness and avoid causing any user discomfort. For example, if a locally-enhanced region of an image frame has an enhanced brightness that is notably different from the brightnesses of adjacent regions, the processor 120 may smooth out the region's brightness over the boundaries therebetween.

A conversion operation 255 generally operates to perform color reconversion on each final brightness-enhanced image frame. This may include the processor 120 converting image data in the YUV, YCbCr, HSV, or other format with a luminance channel to another image format, such as one that lacks a luminance channel (like RGB format). In some embodiments, the conversion operation 255 may convert image frames back into their original image format. Also, in some cases, this may be done to make the final brightness-enhanced image frames compatible for display and to provide improved user experience. As a particular example, this may include the processor 120 determining RGB data or other image data for every pixel based on a YUV, YCbCr, or HSV image frame to generate a new RGB or other image frame. In cases in which an image frame does not need brightness enhancement (local and/or global), conversion may be performed on the original captured image frame after completion of the brightness enhancement decision operation 235. Note, however, that use of the conversion operation 255 is optional.

A passthrough transformation operation 260 generally operates to apply one or more transformations to each final brightness-enhanced image frame (or each original image frame if no brightness enhanced is performed) in order to generate one or more transformed image frames. This may include the processor 120 applying one or more transformations to compensate for things like registration and parallax errors, which may be caused by factors like differences between the positions of the imaging sensor(s) 180 and a user's eyes. That is, captured image frames are captured by one or more imaging sensor(s) 180 at one or more locations, but rendered images are viewed by a user's eyes that are at different locations. The passthrough transformation operation 260 an apply one or more transformations in order to compensate for these differences in viewpoints. In some cases, the passthrough transformation operation 260 may apply a rotation and/or a translation to each image frame in order to compensate for these or other types of issues. Ideally, the transformations give the appearance that the images presented to the user are captured at the locations of the user's eyes, when the image frames in reality are captured at one or more different locations. Often times, the rotation and/or translation can be derived mathematically based on the position and angle of each imaging sensor 180 and the expected or actual positions of the user's eyes. In some cases, the transformations are static (since these positions and angles will not change), allowing passthrough transformations to be applied quickly.

A final image frame rendering operation 265 generally operates to create one or more final views based on the transformed image frames. The final image frame rendering operation 265 can also render the final views for presentation to the user of the electronic device 101. For example, the final image frame rendering operation 265 may process the converted image frames and perform any additional refinements or modifications needed or desired, and the resulting images (referred to here as final image frames or final view frames) can represent the final views of the scene. For instance, a 3D-to-2D warping can be used to warp the final views of the scene into 2D images. The final image frame rendering operation 265 can also present the rendered images to the user. For example, the final image frame rendering operation 265 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes. In some cases, the final image frame rendering operation 265 may combine the transformed images with one or more generated virtual objects to generate the one or more final image frames for display.

Although FIG. 2 illustrates one example of a process 200 for dynamic and adaptive image brightness enhancement, various changes may be made to FIG. 2. For example, various components or functions in FIG. 2 may be combined, further subdivided, replicated, omitted, or rearranged and additional components or functions may be added according to particular needs. Also, different brightness enhancement approaches other than histogram, contrast, and/or exposure processing can be applied for brightness enhancement of image frames.

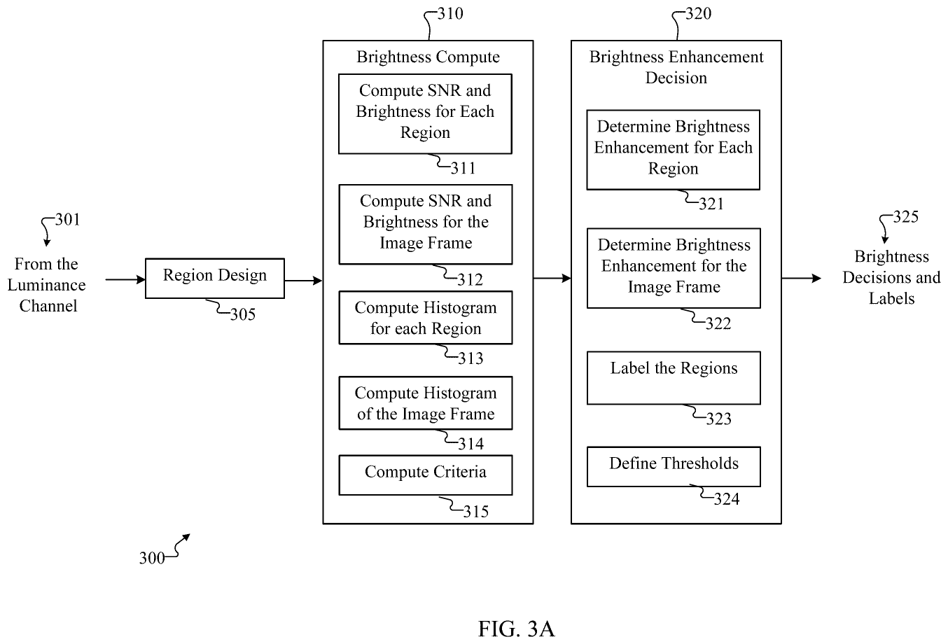

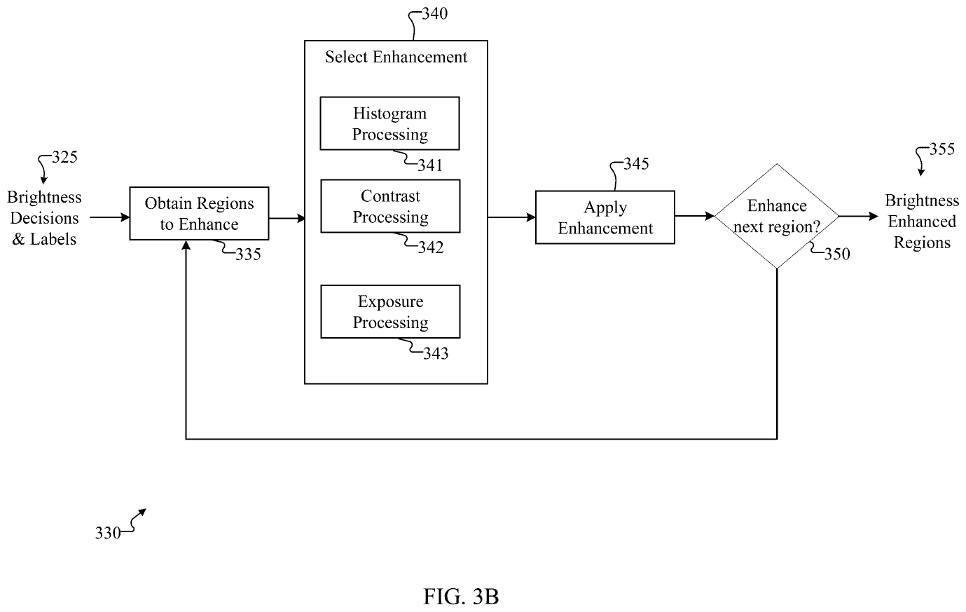

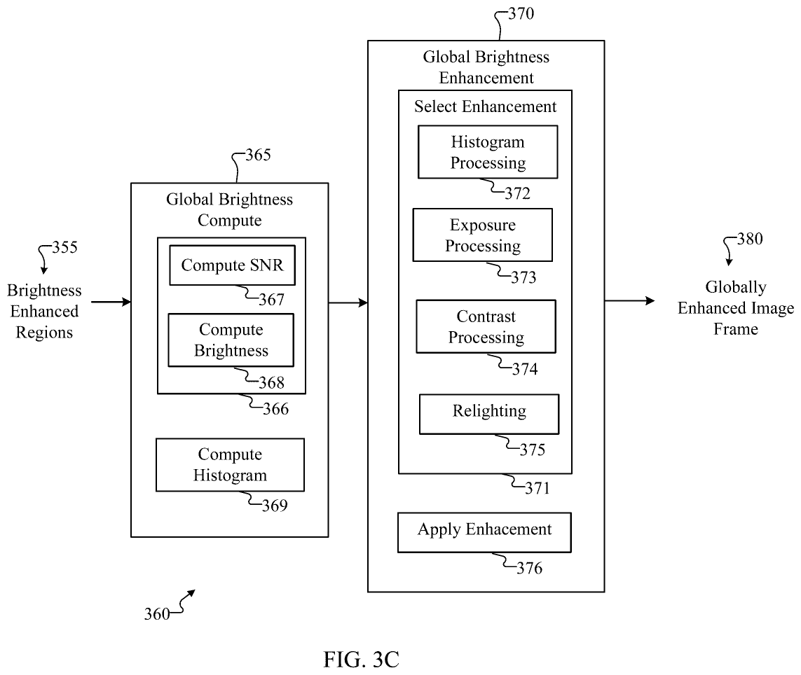

FIGS. 3A-3C illustrate example functions in the process 200 of FIG. 2 in accordance with this disclosure. As shown in FIG. 3A, one operation associated with the process 200 is a brightness analysis operation 300 for a captured image frame. This may be the same as or similar to the brightness enhancement analysis operation 215 of FIG. 2 and can include a region design operation 305, a brightness compute operation 310, and a brightness enhancement decision operation 320. The region design operation 305 generally operates to obtain a color format-converted image frame or other suitable image frame and process a luminance channel 301 for brightness enhancement. The region design operation 305 can also create a plurality of regions in the image frame. This may be the same as or similar to the region design operation 220 of FIG. 2.

The brightness compute operation 310 generally operates to analyze the brightness of extracted image features and may be the same as or similar to the brightness compute operation 225 of FIG. 2. In this example, the brightness compute operation 310 includes a local brightness metrics compute operation 311, a global brightness metrics compute operation 312, a local histogram compute operation 313, a global histogram compute operation 314, and a brightness criteria compute operation 315.

The local brightness metrics compute operation 311 generally operates to determine brightness metrics, such as signal-to-noise ratio and brightness, of each region. This may be done in the same or similar manner as the local brightness compute operation 226 of FIG. 2. The global brightness metrics compute operation 312 generally operates to determine brightness metrics for the image frame as a whole. This may be done in the same or similar manner as the global brightness compute operation 227 of FIG. 2. The local histogram compute operation 313 generally operates to determine a local histogram of each region in the image frame. This may be done in the same or similar manner as the local histogram compute operation 228 of FIG. 2. The global histogram compute operation 314 generally operate to determine a global histogram of the image frame. This may be done in the same or similar manner as the global histogram compute operation 229 of FIG. 2. The brightness criteria compute operation 315 generally operates to determine local and global brightness criteria for the image frame. This may be done in the same or similar manner as the brightness criteria compute operation 230 of FIG. 2.

The brightness enhancement decision operation 320 generally operates to determine whether brightness enhancement is needed for the image frame. This may be done in the same or similar manner as the brightness enhancement decision operation 235 of FIG. 2. In this example, the brightness enhancement decision operation 320 includes a local brightness enhancement decision operation 321, a global brightness enhancement decision operation 322, a label operation 323, and a threshold identification operation 324. These operations may be done in the same or similar manner as the local brightness enhancement decision operation 236, the global brightness enhancement decision operation 237, the label operation 238, and the threshold identification operation 239 of FIG. 2, respectively. The brightness enhancement decisions and labels 325 for one or more regions to be enhanced can be obtained after completion of the brightness analysis operation 300. In some cases, regions that do not need brightness enhancement may be labeled to easily distinguish them from regions labeled for enhancement (so as to expedite subsequent local brightness enhancement operations).

As shown in FIG. 3B, another operation associated with the process 200 is a local brightness enhancement operation 330. This may be performed in the same or similar manner as the local brightness enhancement operation 245 of FIG. 2. In this example, the local brightness enhancement operation 330 includes an identification operation 335, a selection operation 340, an application operation 345, and a determination operation 350. The identification operation 335 generally operates to identify a region labeled for enhancement. This may include the processor 120 obtaining one of the region(s) labeled for enhancement based on the brightness enhancement decisions and a label 325 and identifying a current region for application of local brightness enhancement (which in some cases might be done randomly).

The selection operation 340 generally operates to identify one or more appropriate local brightness enhancements based on the corresponding local brightness metrics. This may be done in the same or similar manner as the selection operation 246 of FIG. 2. In this example, the local brightness enhancements may include local histogram processing 341, local contrast processing 342, and local exposure processing 343. However, this is for illustrative purposes only, and other or additional type(s) of local brightness enhancement can be applied.

The application operation 345 generally operates to apply the one or more selected local brightness enhancements to the current region. This may be done in the same or similar manner as the application operation 247 of FIG. 2. The determination operation 350 generally operates to determine whether all of the one or more regions labeled for enhancement have been enhanced. This may be done in the same or similar manner as the determination operation 248 of FIG. 2. When all regions labeled for enhancement have been enhanced, one or more locally-enhanced regions 355 can be output for final global brightness enhancement.

As shown in FIG. 3C, yet another operation that may be associated with the process 200 is a global brightness enhancement operation 360 for a locally-enhanced image frame as a whole. This may be done in the same or similar manner as the global brightness enhancement operation 250 of FIG. 2. In this example, the global brightness enhancement operation 360 includes a global brightness compute operation 365 and a global brightness enhancement operation 370.

The global brightness compute operation 365 generally operates to obtain locally-enhanced regions 355 to finalize brightness enhancement. In this example, the global brightness compute operation 365 includes a global brightness metrics compute operation 366 and a global histogram compute operation 369. The global brightness metrics compute operation 366 generally operates to determine global brightness metrics and may include a global signal-to-noise ratio compute operation 367 and a global brightness compute operation 368. The global signal-to-noise ratio compute operation 367 generally operates to determine a global signal-to-noise ratio SNR_{f} for an image frame, such as by using Equation (8). The global brightness compute operation 368 generally operates to determine a global brightness Brightness of the image frame, such as by using Equation (10). The global histogram compute operation 369 generally operates to determine a histogram of the image frame as a whole after local brightness enhancement. This may be done in the same or similar manner as the global histogram compute operation 252 of FIG. 2.

The global brightness enhancement operation 370 may include a selection operation 371 and an application operation 376. The selection operation 371 generally operates to select one or more appropriate global brightness enhancements based on the global metrics and histogram. This may be done in the same or similar manner as the selection operation 253 of FIG. 2. Here, global brightness enhancements may include global histogram processing 372, global exposure processing 373, global contrast processing 374, and relighting 375. The application operation 376 generally operates to apply the one or more selected global brightness enhancements. This may be done in the same or similar manner as the application operation 254 of FIG. 2. A globally-enhanced image frame 380 can be output, such as when the image frame 380 is passed to the conversion operation 255 of FIG. 2.

Although FIGS. 3A-3C illustrate examples of functions in the process 200 of FIG. 2, various changes may be made to FIGS. 3A-3C. For example, various components or functions in each of FIGS. 3A-3C may be combined, further subdivided, replicated, omitted, or rearranged and additional components or functions may be added according to particular needs. Also, different local and/or global brightness enhancements (such as gamma correction, tone mapping, deep-learning based enhancement, and the like) can be applied.

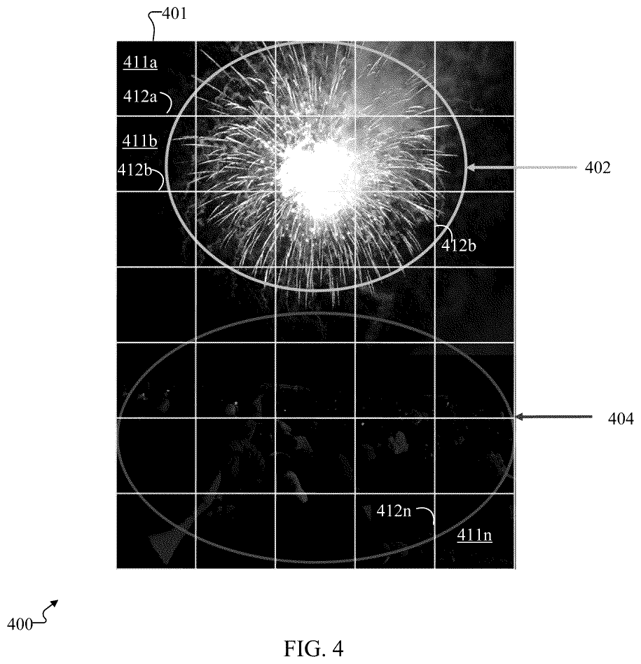

FIG. 4 illustrates an example technique 400 for region design for an image frame 401 capturing a scene in accordance with this disclosure. For case of explanation, the technique 400 is described as being performed using the electronic device 101 in the network configuration 100 shown in FIG. 1, where the electronic device 101 may implement the process 200 shown in FIG. 2. However, the technique 400 may be performed using any other suitable device(s) and in any other suitable system(s).

As shown in FIG. 4, the image frame 401 includes image features, such as fireworks and spectators, and is divided into a plurality of regions 411a-411n. Each region 411a-411n has one or more shared boundaries with one or more adjacent regions. For example, the region 411a and the region 411b share a boundary 412a. In some cases, the regions 411a-411n can be adapted from a pre-designed grid or other pattern based on the actual image features detected within the image frame 401.

An area 402 of the image frame 401 including the fireworks has a higher brightness than an area 404 of the image frame 401 including the spectators. Also, the area 404 has a lower contrast such that the spectators have low visibility. Thus, at least the regions within the area 404 can be enhanced using one or more local brightness enhancements (such as local contrast processing). In addition, one or more boundaries (such as a boundary 412b) may be modified post-local brightness enhancement so as to smooth sharp differences in brightnesses between adjacent regions, which can be done to achieve more global brightness consistency.

Although FIG. 4 illustrates one example of a technique 400 for region design for an image frame 401, various changes may be made to FIG. 4. For example, the contents of the image frame 401 and the defined regions 411a-411n can vary widely based on the actual contents of a scene being imaged.

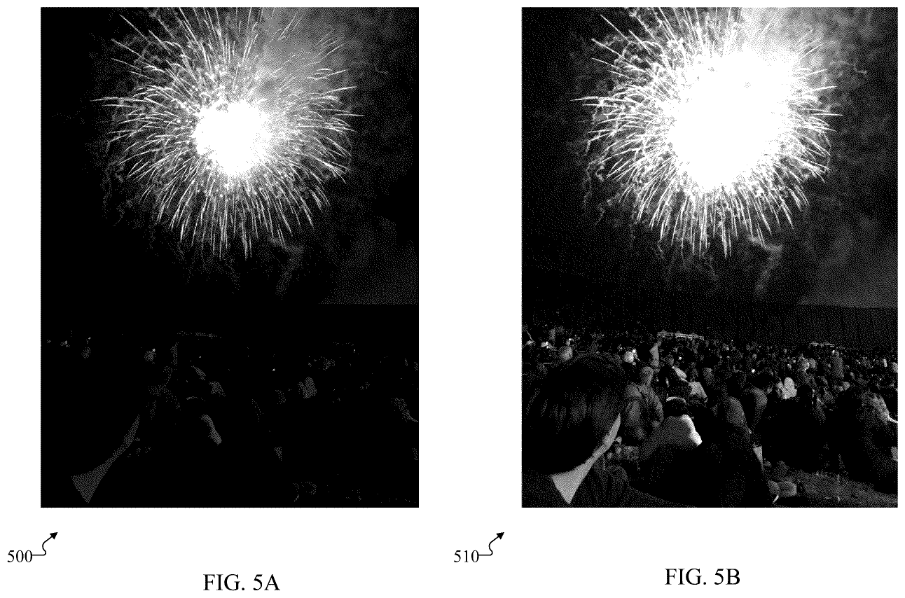

FIGS. 5A-5B illustrate an example result obtainable using dynamic and adaptive image brightness enhancement in accordance with this disclosure. More specifically, FIG. 5A illustrates an example original captured image 500 prior to application of dynamic and adaptive image brightness enhancement. As can be seen here, the original captured image 500 appears to have low brightness in the image as a whole, thereby making it difficult to identify spectators in a bottom of the image 500. Among other things, this can cause discomfort to a user viewing the original captured image 500 or otherwise reduce the user's experience.

An example brightness-enhanced image 510 shown in FIG. 5B may be generated using the dynamic and adaptive image brightness enhancement described above. As can be seen here, the resulting image 510 improves the brightness and contrast of the dark areas, accentuates the brightness of the fireworks, and increases the visibility of the spectators. Also, the brightness and contrast in the resulting image 510 are more consistent throughout the image 510 than in the original image 500. Among other reasons, this is because the electronic device 101 is able to perform dynamic and adaptive image brightness enhancement that is tailored to correct regional brightness deficiencies while providing global brightness consistency throughout the image 510. This can result in significant improvements in the user's experience.

Although FIGS. 5A-5B illustrate one example of results obtainable using dynamic and adaptive image brightness enhancement, various changes may be made to FIGS. 5A-5B. For example, FIGS. 5A-5B are merely meant to illustrate one example of a type of benefit that might be obtained using the techniques of this disclosure. The specific results that are obtained in any given situation can vary based on the circumstances and based on the specific implementation of the techniques described in this disclosure.

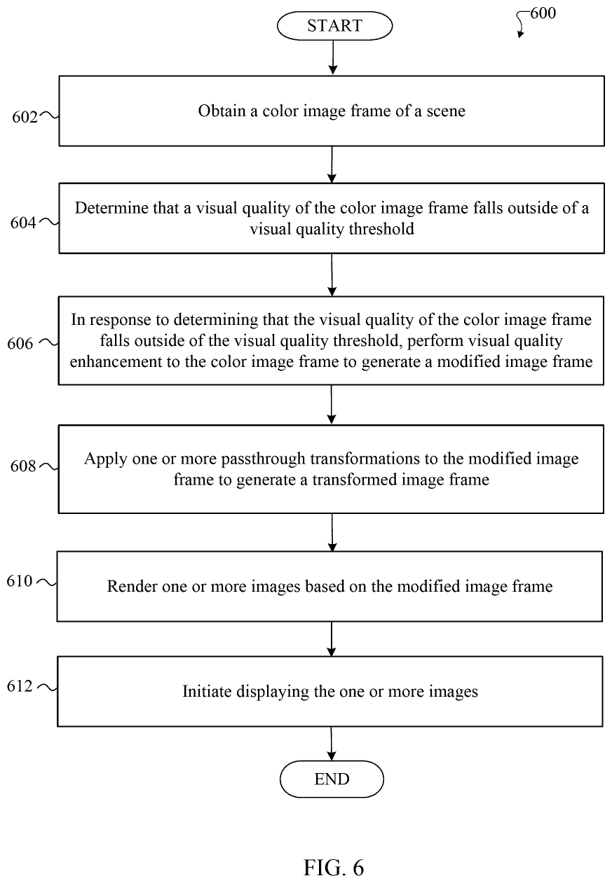

FIG. 6 illustrates an example method 600 for dynamic and adaptive image brightness enhancement in accordance with this disclosure. For case of explanation, the method 600 shown in FIG. 6 is described as being performed using the electronic device 101 in the network configuration 100 shown in FIG. 1, where the electronic device 101 may implement the process 200 shown in FIG. 2. However, the method 600 may be performed using any other suitable device(s) and in any other suitable system(s), and the method 600 may be implemented using any other suitable process(es) or architecture(s) designed in accordance with this disclosure.

As shown in FIG. 6, at step 602, a color image frame of a scene is obtained. This may include, for example, the processor 120 of the electronic device 101 obtaining a color image frame using one or more imaging sensors 180 of the electronic device 101. At step 604, a visual quality of the color image frame is determined to fall outside of a visual quality threshold. This may include, for example, the processor 120 of the electronic device 101 determining if one or more local/regional or global visual quality parameters fall outside a range of suitable values or differ from a specified value by more than a threshold amount or percentage.

In some embodiments, the processor 120 of the electronic device 101 may segment the color image frame into a plurality of regions and obtain regional visual quality parameters for each of the regions and global visual quality parameters for the color image frame. The regional visual quality parameters may include a regional signal-to-noise ratio, a regional brightness, and a regional histogram. The global visual quality parameters may include a global signal-to-noise ratio, a global brightness, and a global histogram. The processor 120 of the electronic device 101 may also identify a regional visual quality threshold for each region based on the regional visual quality parameters associated with the region and identify a global visual quality threshold for the color image frame based on the global visual quality parameters. The processor 120 of the electronic device 101 may further label one or more first regions to be enhanced and one or more second regions to not be enhanced. In some cases, each first region may have an associated regional visual quality parameter that falls outside of the regional visual quality threshold associated with the first region, and each second region may have an associated regional visual quality parameter within the regional visual quality threshold associated with the second region.

At step 606, in response to determining that the visual quality of the color image frame falls outside of the visual quality threshold, visual quality enhancement to the color image frame is performed to generate a modified image frame. This may include, for example, the processor 120 of the electronic device 101 applying a local visual enhancement to one or more regions of the color image frame and/or applying a global visual enhancement to the color image frame. In some cases, this may include the processor 120 of the electronic device 101 selecting one or more visual enhancement algorithms for the one or more regions and applying the one or more visual enhancement algorithms to the one or more regions. The one or more visual enhancement algorithms may include at least one of: a histogram processing, a contrast processing, or an exposure processing. Also, in some cases, this may include the processor 120 of the electronic device 101 selecting one or more global visual enhancement algorithms for the color image frame and applying the one or more visual enhancement algorithms to the color image frame such that the brightness is more consistent throughout the color image frame. The one or more global visual enhancement algorithms may include at least one of: a histogram processing, an exposure processing, a contrast processing, or a relighting,

At step 608, one or more passthrough transformations are applied to the modified image frame to generate a transformed image frame. This may include, for example, the processor 120 of the electronic device 101 applying one or more passthrough transformations, such as for parallax correction, to the modified image frame. At step 610, one or more images are rendered based on the modified or transformed image frame for display. At step 612, display of the one or more rendered images is initiated. This may include, for example, the processor 120 of the electronic device 101 rendering one or more images based on the transformed image frame and displaying the rendered images on at least one display 160 of the electronic device 101.

Although FIG. 6 illustrates one example of a method 600 for dynamic and adaptive attentional region generation and rendering, various changes may be made to FIG. 6. For example, while shown as a series of steps, various steps in FIG. 6 may overlap, occur in parallel, occur in a different order, or occur any number of times (including zero times). Also, while not shown here, color format conversion of the color image frame may be performed as described above.

It should be noted that the functions shown in or described with respect to FIGS. 2 through 6 can be implemented in an electronic device 101, 102, 104, server 106, or other device(s) in any suitable manner. For example, in some embodiments, at least some of the functions shown in or described with respect to FIGS. 2 through 6 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 6 can be implemented or supported using dedicated hardware components. In general, the functions shown in or described with respect to FIGS. 2 through 6 can be performed using any suitable hardware or any suitable combination of hardware and software/firmware instructions. Also, the functions shown in or described with respect to FIGS. 2 through 6 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one imaging sensor of an electronic device, a color image frame of a scene;
determining, using at least one processing device of the electronic device, that a visual quality of the color image frame falls outside of a visual quality threshold;
in response to determining that the visual quality of the color image frame falls outside of the visual quality threshold, performing, using the at least one processing device, visual quality enhancement to the color image frame to generate a modified image frame; and
applying, using the at least one processing device, one or more passthrough transformations to the modified image frame to generate a transformed image frame.

2. The method of claim 1, wherein determining that the visual quality of the color image frame falls outside of the visual quality threshold comprises:
segmenting the color image frame into a plurality of regions;
obtaining regional visual quality parameters for each of the regions and global visual quality parameters for the color image frame, the regional visual quality parameters including a regional signal-to-noise ratio, a regional brightness, and a regional histogram, the global visual quality parameters including a global signal-to-noise ratio, a global brightness, and a global histogram;
identifying a regional visual quality threshold for each region based on the regional visual quality parameters associated with the region; and
identifying a global visual quality threshold for the color image frame based on the global visual quality parameters.

3. The method of claim 2, further comprising:
labeling one or more first regions to be enhanced and one or more second regions to not be enhanced;
wherein each first region has an associated regional visual quality parameter that falls outside of the regional visual quality threshold associated with the first region; and
wherein each second region has an associated regional visual quality parameter within the regional visual quality threshold associated with the second region.

4. The method of claim 2, wherein performing the visual quality enhancement comprises at least one of:
applying a local visual enhancement to one or more of the regions; or
applying a global visual enhancement to the color image frame.

5. The method of claim 4, wherein applying the local visual enhancement comprises:
selecting one or more visual enhancement algorithms for the one or more regions, the one or more visual enhancement algorithms including at least one of: a histogram processing, a contrast processing, or an exposure processing; and
applying the one or more visual enhancement algorithms to the one or more regions.

6. The method of claim 4, wherein applying the global visual enhancement comprises:
selecting one or more global visual enhancement algorithms for the color image frame, the one or more global visual enhancement algorithms including at least one of: a histogram processing, an exposure processing, a contrast processing, or a relighting; and
applying the one or more visual enhancement algorithms to the color image frame such that the brightness is more consistent throughout the color image frame.

7. The method of claim 1, further comprising:
converting a color format of the color image frame;
extracting a luminance component from the converted color format of the color image frame; and
determining brightness of the color image frame using the luminance component.

8. The method of claim 1, further comprising:
rendering a final image frame for display based on the transformed image frame.

9. An apparatus comprising:
at least one processing device configured to:
obtain a color image frame of a scene;
determine that a visual quality of the color image frame falls outside of a visual quality threshold;
in response to determining that the visual quality of the color image frame falls outside of the visual quality threshold, perform visual quality enhancement to the color image frame to generate a modified image frame; and
apply one or more passthrough transformations to the modified image frame to generate a transformed image frame.

10. The apparatus of claim 9, wherein, to determine that the visual quality of the color image frame falls outside of the visual quality threshold, the at least one processing device is configured to:
segment the color image frame into a plurality of regions;
obtain regional visual quality parameters for each of the regions and global visual quality parameters for the color image frame, the regional visual quality parameters including a regional signal-to-noise ratio, a regional brightness, and a regional histogram, the global visual quality parameters including a global signal-to-noise ratio, a global brightness, and a global histogram;
identify a regional visual quality threshold for each region based on the regional visual quality parameters associated with the region; and
identify a global visual quality threshold for the color image frame based on the global visual quality parameters.

11. The apparatus of claim 10, wherein:
the at least one processing device is further configured to label one or more first regions to be enhanced and one or more second regions to not be enhanced;
each first region has an associated regional visual quality parameter that falls outside of the regional visual quality threshold associated with the first region; and
each second region has an associated regional visual quality parameter within the regional visual quality threshold associated with the second region.

12. The apparatus of claim 10, wherein, to perform the visual quality enhancement, the at least one processing device is configured to at least one of:
apply a local visual enhancement to one or more of the regions; or
apply a global visual enhancement to the color image frame.

13. The apparatus of claim 12, wherein, to apply the local visual enhancement, the at least one processing device is configured to:
select one or more visual enhancement algorithms for the one or more regions, the one or more visual enhancement algorithms including at least one of: a histogram processing, a contrast processing, or an exposure processing; and
apply the one or more visual enhancement algorithms to the one or more regions.

14. The apparatus of claim 12, wherein, to apply the global visual enhancement, the at least one processing device is configured to:
select one or more global visual enhancement algorithms for the color image frame, the one or more global visual enhancement algorithms including at least one of: a histogram processing, an exposure processing, a contrast processing, or a relighting; and
apply the one or more visual enhancement algorithms to the color image frame such that the brightness is more consistent throughout the color image frame.

15. The apparatus of claim 9, wherein the at least one processing device is further configured to:
convert a color format of the color image frame;
extract a luminance component from the converted color format of the color image frame; and
determine brightness of the color image frame using the luminance component.

16. A non-transitory machine readable medium containing instructions that when executed cause at least one processor of an electronic device to:
obtain a color image frame of a scene;
determine that a visual quality of the color image frame falls outside of a visual quality threshold;
in response to determining that the visual quality of the color image frame falls outside of the visual quality threshold, perform visual quality enhancement to the color image frame to generate a modified image frame; and
apply one or more passthrough transformations to the modified image frame to generate a transformed image frame.

17. The non-transitory machine readable medium of claim 16, wherein the instructions that when executed cause the at least one processor to determine that the visual quality of the color image frame falls outside of the visual quality threshold comprise instructions that when executed cause the at least one processor to:
segment the color image frame into a plurality of regions;
obtain regional visual quality parameters for each of the regions and global visual quality parameters for the color image frame, the regional visual quality parameters including a regional signal-to-noise ratio, a regional brightness, and a regional histogram, the global visual quality parameters including a global signal-to-noise ratio, a global brightness, and a global histogram;
identify a regional visual quality threshold for each region based on the regional visual quality parameters associated with the region; and
identify a global visual quality threshold for the color image frame based on the global visual quality parameters.

18. The non-transitory machine readable medium of claim 17, wherein:
the instructions that when executed cause the at least one processor to determine that the visual quality of the color image frame falls outside of the visual quality threshold further comprise instructions that when executed cause the at least one processor to label one or more first regions to be enhanced and one or more second regions to not be enhanced;
each first region has an associated regional visual quality parameter that falls outside of the regional visual quality threshold associated with the first region; and
each second region has an associated regional visual quality parameter within the regional visual quality threshold associated with the second region.

19. The non-transitory machine readable medium of claim 17, wherein the instructions that when executed cause the at least one processor to perform the visual quality enhancement comprise instructions that when executed cause the at least one processor to at least one of:
apply a local visual enhancement to one or more of the regions; or
apply a global visual enhancement to the color image frame.

20. The non-transitory machine readable medium of claim 19, wherein:
the instructions that when executed cause the at least one processor to apply the local visual enhancement comprise instructions that when executed cause the at least one processor to:
select one or more visual enhancement algorithms for the one or more regions, the one or more visual enhancement algorithms including at least one of: a histogram processing, a contrast processing, or an exposure processing; and
apply the one or more visual enhancement algorithms to the one or more regions; and
the instructions that when executed cause the at least one processor to apply the global visual enhancement comprise instructions that when executed cause the at least one processor to:
select one or more global visual enhancement algorithms for the color image frame, the one or more global visual enhancement algorithms including at least one of: a histogram processing, an exposure processing, a contrast processing, or a relighting; and
apply the one or more visual enhancement algorithms to the color image frame such that the brightness is more consistent throughout the color image frame.
